(19) United States
(12) Patent Application Publication
(10) Pub. No.: US 2018/0357583 A1
(43) Pub. Date: Dec. 13, 2018

(54) OPERATIONAL MONITORING SYSTEM

(71) Applicant: Optical Operations LLC, Roland, IA (US)

(72) Inventor: Andrew Guillemette, Roland, IA (US)

(21) Appl. No.: 16/006,729

(22) Filed: Jun. 12, 2018

Related U.S. Application Data
(60) Provisional application No. 62/518,183, filed on Jun. 12, 2017.

(51) Int. Cl. G06Q 10/06; G06F 13/42; H04N 7/18; G06T 17/05

(52) U.S. Cl. CPC G06Q 10/06311; G06F 13/4282; G06T 2200/08; G06T 17/05; H04N 7/181

(57) ABSTRACT

The present invention relates to an operational monitoring system that collects information in real-time from a work-site with a personnel tracking system, an equipment tracking system. The collected information is sent to a server, which is received and presented on an interactive display system that uses information capture by a site rendering system to render a 3D model of the work-site. A task management system allows an end-user to assign work profiles, tasks, and zones for workers and equipment operating on-site, which is thereafter monitored in real-time.

### CROSS REFERENCE TO RELATED APPLICATION

This application claims the benefit of U.S. Provisional Application No. 62/518,183 filed Jun. 12, 2017.

### BACKGROUND OF THE INVENTION

This invention is directed toward a monitoring system. More specifically, and without limitation, this invention relates to an operational monitoring system for providing real-time or near real-time monitoring of construction sites.

Presently, to monitor one or more construction sites requires that a general contractor or supervisor conduct an on-site visit for each site. This is time-consuming, inaccurate, and inefficient as the information received by the supervisor must be relayed to the supervisor by another person present on-site, which inherently leads to incomplete or incorrect information being provided. The relayed information that is provided is naturally retrospective, which further diminishes the value of the provided information. This process must be repeated for each construction site being supervised, which for large-scale projects can mean visiting numerous locations to retrieve the information the supervisor desires to obtain.

The need for the supervisor to be on-site leads to other issues. Primarily, the supervisor is not able to coordinate, schedule, and prioritize tasks based on the machinery, equipment, and personnel available at any given time, which is vital to reduce expenses and meet development milestones. This is especially true given the numerous changes that can occur while the supervisor isn't present, such as delayed shipments, conflicts in schedules, and tardy or absent contractors. As a result, a supervisor lacks the details necessary to make informed decisions related to each construction site.

One advancement that has taken place is the use of global-positioning satellites (GPS) on equipment. These advancements have their deficiencies. For instance, the use of GPS is limited and difficult to interpret in relation to a project, which is fluid in nature as progress is made. Moreover, the mere presence of a piece of machinery or equipment provides little to no value with respect to the work being completed. For instance, a cement truck may be positioned near a construction site, but it is entirely unclear whether the cement truck is operating or not.

Video feeds have also been utilized, but it is often difficult, if not impossible, to discern what a particular worker is doing. For example, if a video feed shows four individuals near a cement truck, it is assumed each person present is involved in the task of laying cement. However, it is also possible that of the four individuals, one or more is present for an unrelated task that is not being worked on.

Digital punch cards have been used to identify what workers are located in particular areas and for how long. However, the different designated areas are often too large and encompasses an area that multiple, widely varying tasks are being worked on and provide no way of knowing where a worker is within a particular area. Further, the use of digital punch cards can require the setup and maintenance of multiple entry ways that require workers to go out of their way to punch-in once they have arrived to work.

Another advancement that has taken place is controller area networks (CAN-bus) that permit microcontrollers or electronic control units (ECU) to monitor vehicle subsystems to diagnose or report on failures, errors, and maintenance. However, the localization of this information dramatically reduces its usefulness as machinery may break down and not be addressed until the next time the supervisor is on-site, or is called back by someone on-site.

Therefore, there is a need in the art to provide an operational monitoring system that improves upon the art.

Another objective of this invention is to provide an operational monitoring system that provides accurate, complete, and real-time information about a work-site.

Yet another objective of this invention is to provide an operational monitoring system that monitors and evaluates machinery, equipment, and personnel from a remote location.

Another objective of this invention is to provide an operational monitoring system that provides a three-dimensional interactive display of a work-site.

Yet another objective of this invention is to provide an operational monitoring system that provides monitoring, efficiency, and progress information from anywhere at any time.

Another objective of this invention is to provide an operational monitoring system that stores historic data, including video, for evaluation and review.

Yet another objective of this invention is to provide an operational monitoring system that increases efficiency, decreases costs, saves money, improves safety and security, and facilitates communication.

Another objective of this invention is to provide an operational monitoring system that provides real-time supervision of multiple work-sites that are remote from one another in a contextual environment.

Yet another objective of this invention is to provide an operational monitoring system that provides for fluid communication between numerous individuals.

Another objective of this invention is to provide an operational monitoring system that collects and provides on-demand, real-time strategic work-site information for off-site use.

These and other objectives, features, and advantages of the invention will become apparent from the specification and claims.

### SUMMARY OF THE INVENTION

In general, the present invention relates to an operating monitoring system. The operating monitoring system includes a site rendering system that captures images from a series of cameras positioned about a work-site. The images are sent to a server to be processed and analyzed in order for the server to render a real-time, model of the work-site, which is displayed in a 3D environment on a remote device, such as a laptop that is remote from the work-site. Additionally, a personnel tracking system and an equipment tracking system record and collect information on workers and construction equipment located at the work-site, including the position and movement of workers and construction equipment, which can be used to determine efficiencies and reliability of workers. The tracking systems also collect diagnostic information, such as the operational and maintenance conditions of the construction equipment and whether workers are complying with safety regulations.

A task management system allows for the designation of tasks and zones for the work-site, which are assigned to workers to complete at scheduled times. Through the use of an interactive display system, an end user, such as a supervisor, can monitor progress at a work site and be automatically alerted if certain conditions occur, including accidents, near accidents, equipment failures, and absent or tardy workers in real-time on through playback of store video and data.

### BRIEF DESCRIPTION OF THE DRAWINGS

FIG. 1 is a perspective view of an operational monitoring system;

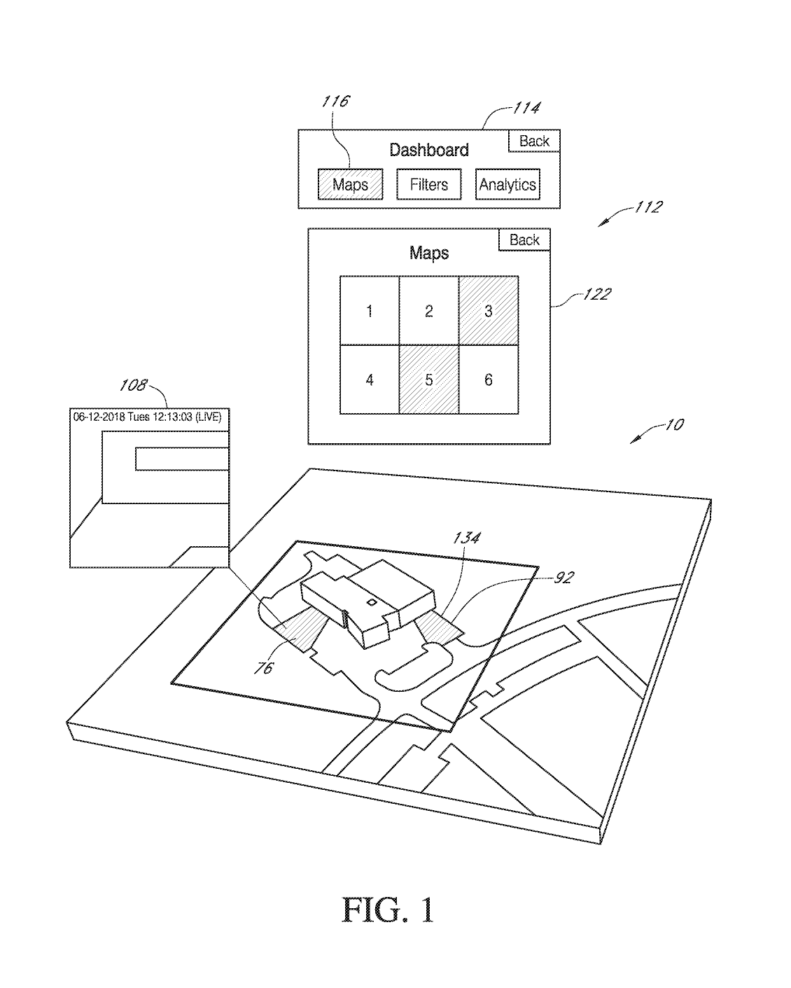

FIG. 2 is a perspective view of an operational monitoring system;

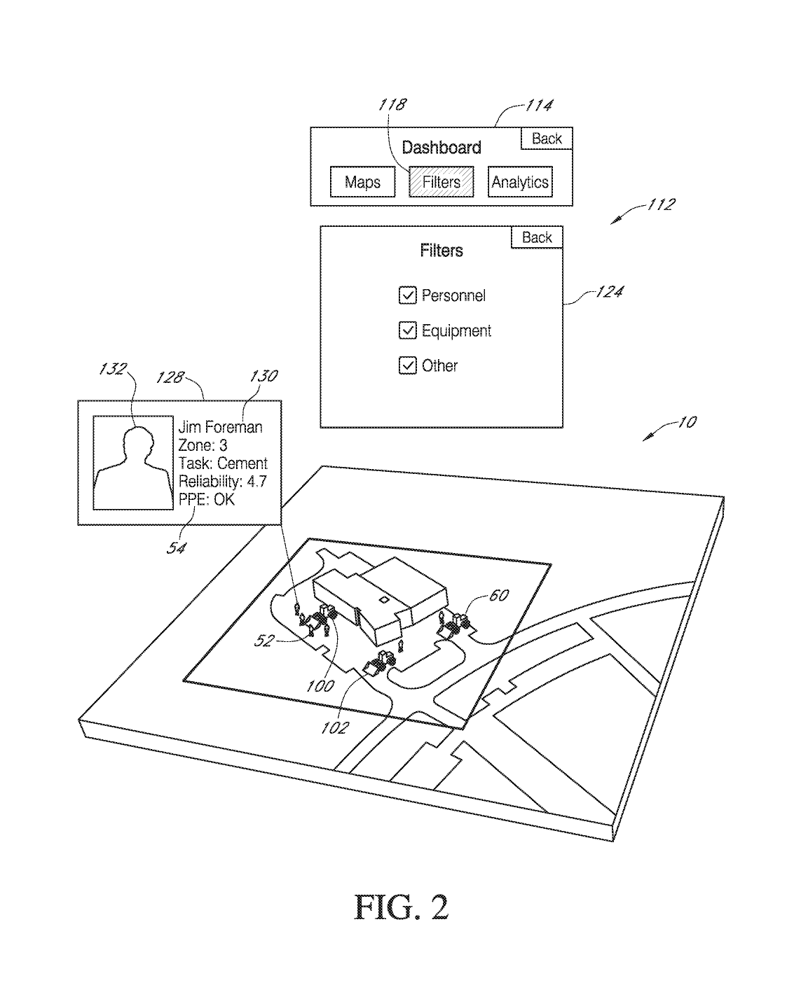

FIG. 3 is a perspective view of an operational monitoring system;

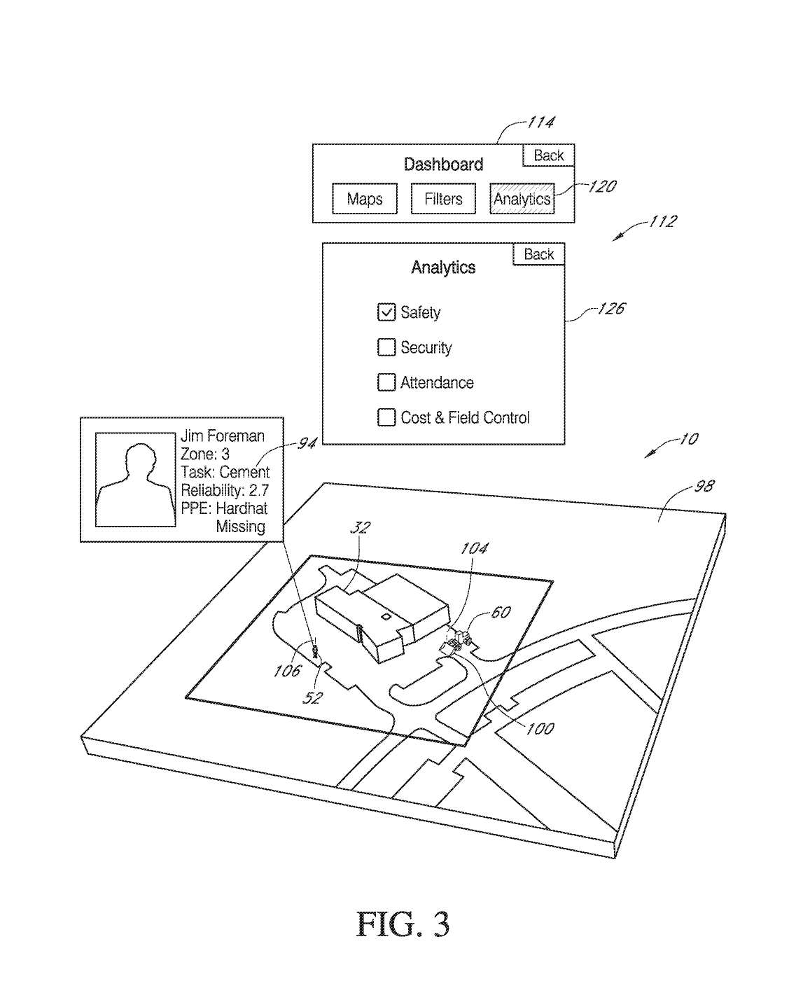

FIG. 4A is a perspective view of an operational monitoring system;

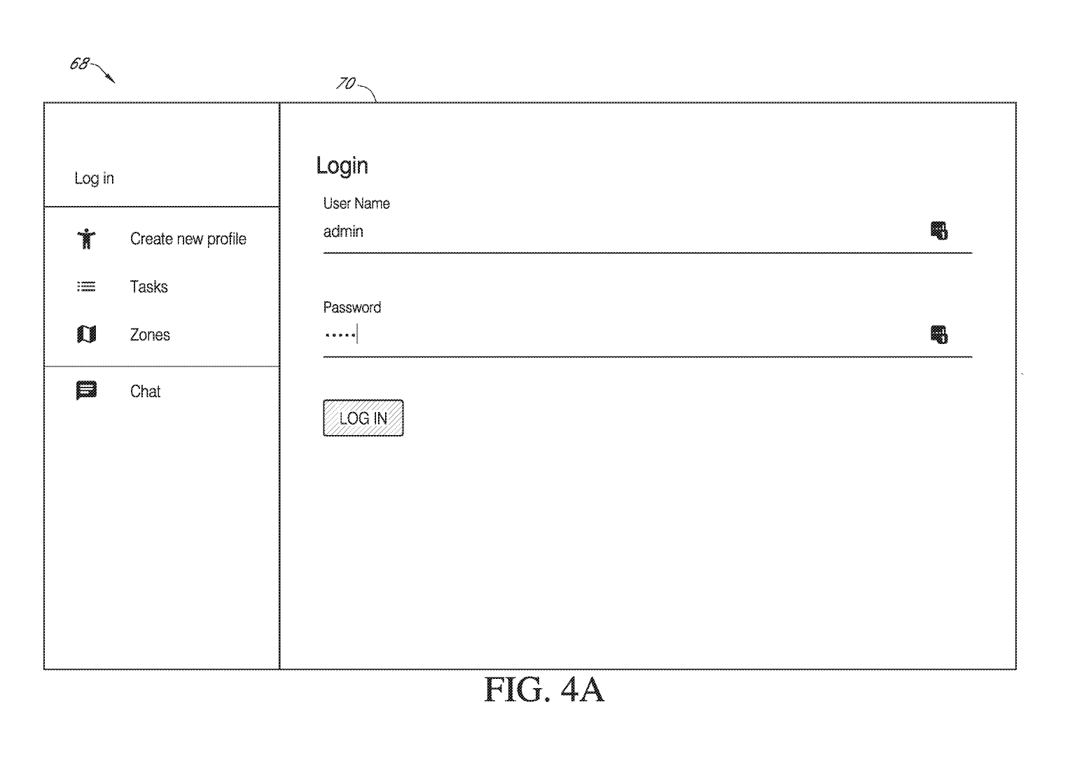

FIG. 4B is a perspective view of an operational monitoring system;

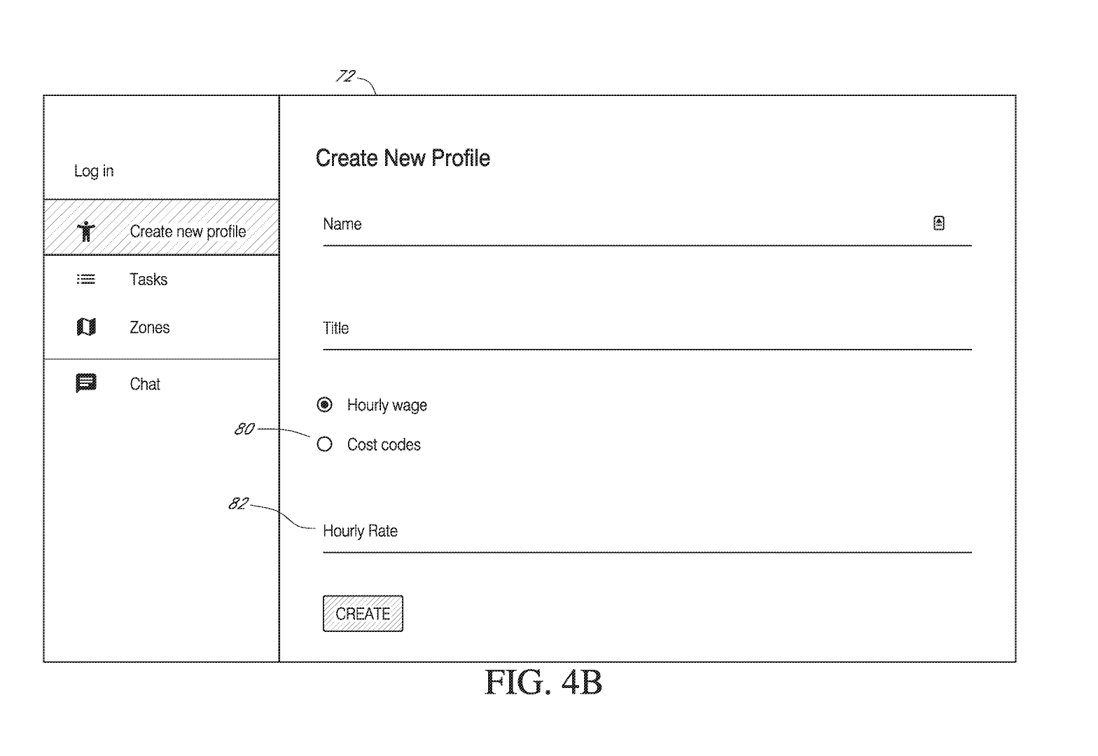

FIG. 4C is a perspective view of an operational monitoring system;

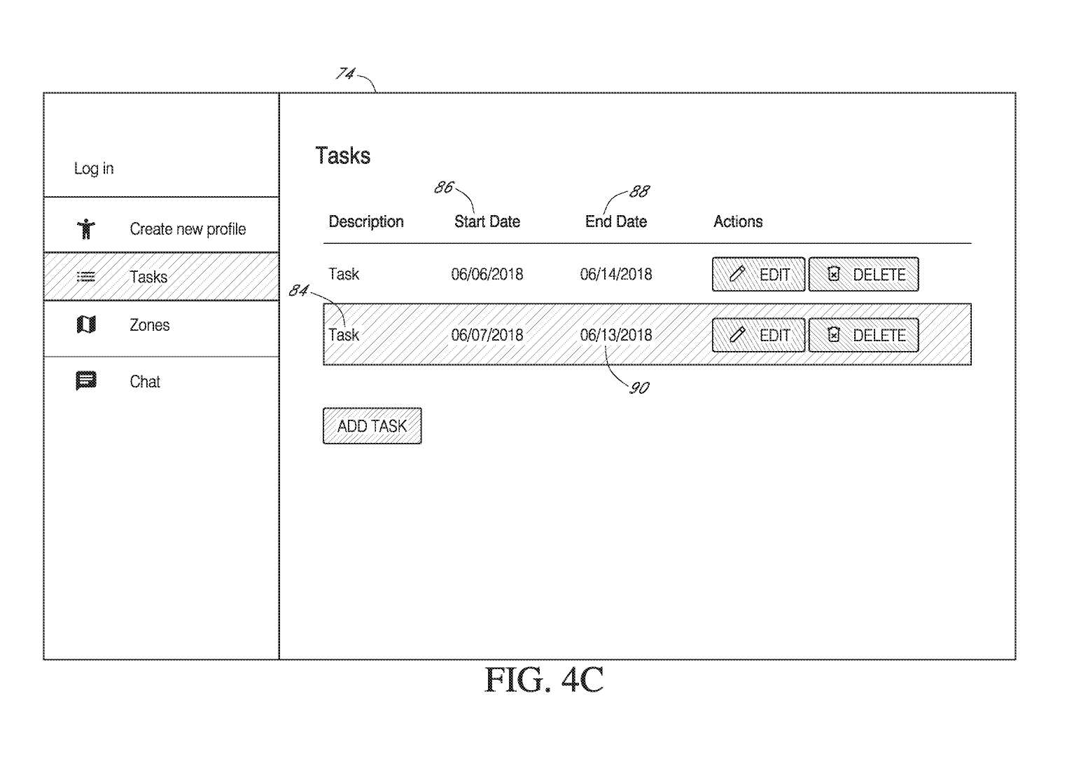

FIG. 4D is a perspective view of an operational monitoring system;

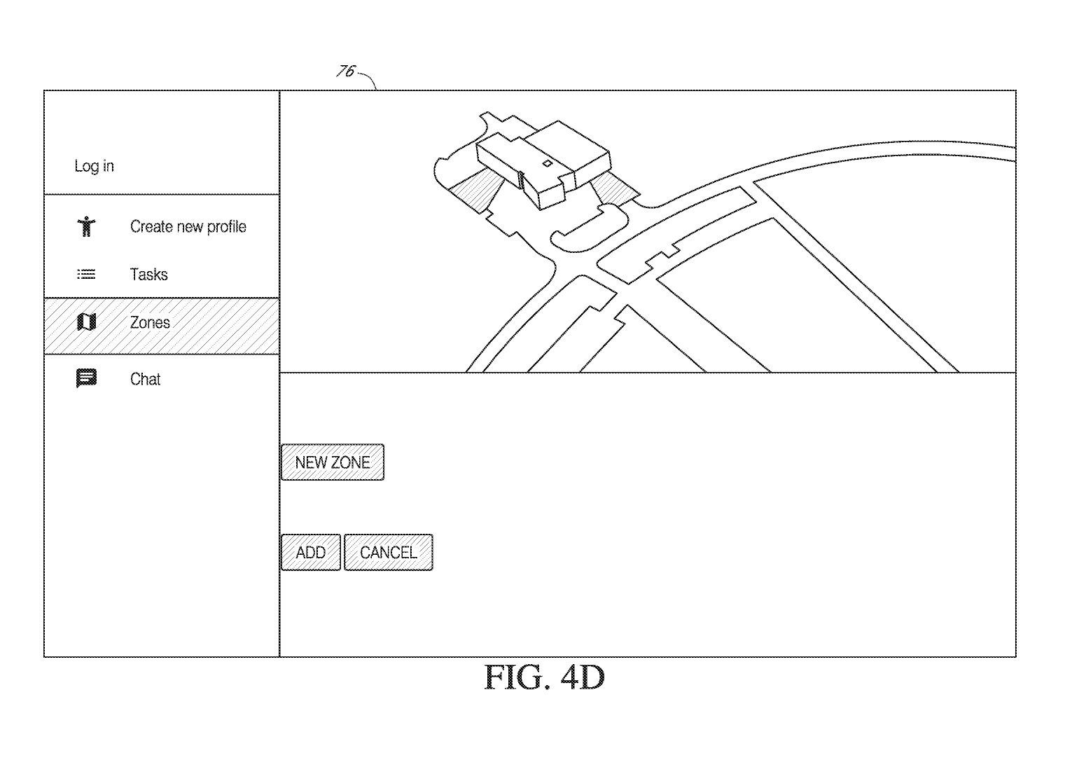

FIG. 4E is a perspective view of an operational monitoring system; and

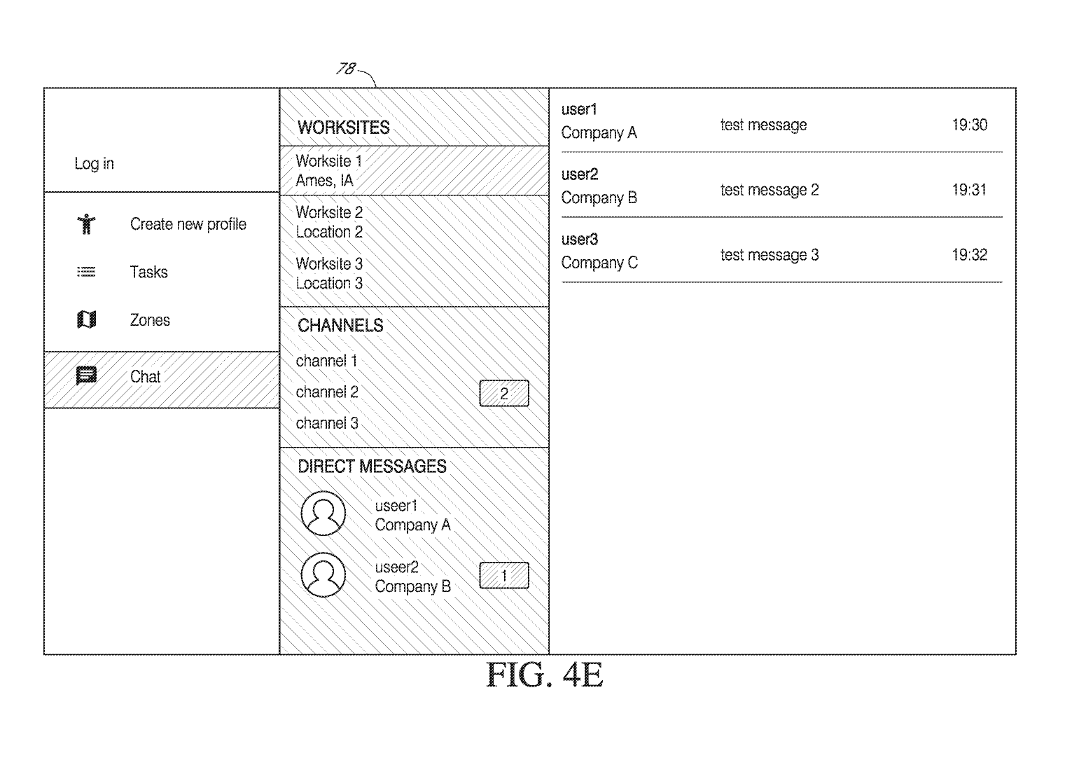

FIG. 5 is a schematic view of an operational monitoring system.

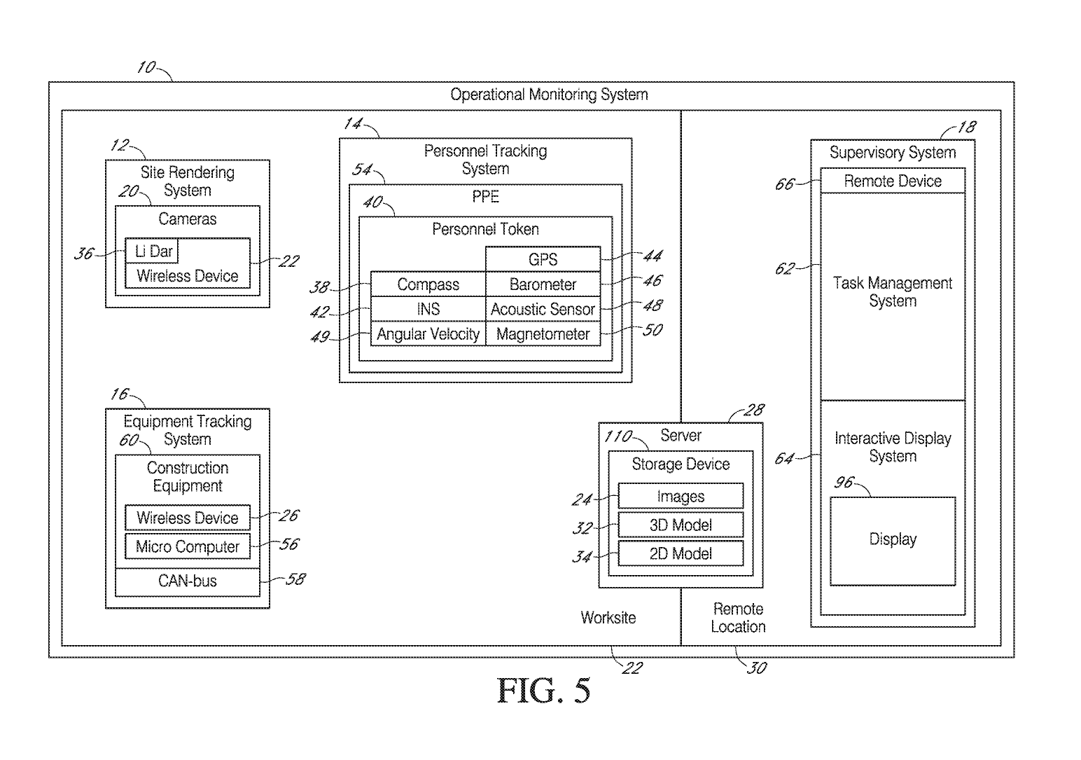

### DETAILED DESCRIPTION

With reference to the figures an operational monitoring system 10 is shown having a site rendering system 12, a personnel tracking system 14, an equipment tracking system 16, and a supervisory system 18.

The site rendering system 12 has a plurality of cameras 20 having positions around a work-site 22. The cameras 20 are configured to capture one or more images 24 that overlap with one another. The images 24 are transferred from the cameras 20 by a wireless device 26 on each camera 20 to a server 28 that is either at the work-site 22 or at a remote location 30 from the work-site 22. The wireless device 26 can be WiFi, Bluetooth, cellular, or other long-range or near-field communication (NFC) device.

The server 28 processes the images 24 using photogrammetry, which analyzes and extracts information from the images 24 to render a 3D model 32 of the work-site 22. In some instances, the server 28 renders a 2D Model 34. A LiDar (laser scanning) device or micro optical mechanical (MOEMS) LiDar device 36 in combination with the cameras 20 is used in some embodiments to provide greater accuracy in the render. For even higher degrees of accuracy in the 3D model 32 or 2D Model 34, iDAR™ is utilized, which combines a MOEMS LiDar device 36 pre-fused with a low light camera 20 and embedded artificial intelligence (Al). In some embodiments using iDAR™, computer vision is used to provide the images 24 to be understood, extracted, and analyzed using Al in order to provide superior processing of the 3-dimensional aspects present in the images 24.

In some arrangements of the present invention, the cameras 20 are positioned in static positions about the work-site 22 during the duration of the construction. This allows the 3D model 32 or 2D model 34 to be routinely updated a predetermined interval, which in some embodiments is every hour or less. In this way, visual confirmation of progress is available day-to-day, as well as throughout a particular day.

The personnel tracking system 14 includes one or more personnel tokens 40. The personnel token 40 has a combination of an inertial navigational system (INS) 42, a GPS module 44, a barometer 46, a compass 38, an acoustic sensor 48, an angular velocity sensor 49, a magnetometer 50, and one or more wireless device 26. The personnel token 40 allows the tracking of the position, movement, and orientation. In one illustrative example of the present invention, the personnel token 40 transmits information to the server 28, which in turn utilizes Wi-Fi triangulation, acceleration, rotation, and latitude in longitude to derive the current position, movement, and orientation of a worker 52.

In some arrangements, the personnel token 40 is connected to or encompassed in a personal protective equipment (PPE) 54 of the worker 52 such as a hard hat, a reflective vest, and a pair of safety goggles or glasses. The intercommunications between personnel tokens 40 allows the absence of one or more PPE 54 to be recognized and transmitted to the server. For example, if the personnel token 40 located in a hard hat did not have a high signal strength from the wireless device 26 to the other PPE 54 of the worker 52 the missing PPE 54 is reported to the server 28.

In situations where one or more worker 52 is outside the range to transmit directly to the server, the wireless device 26 for each personnel token 40 permits communication with another personnel token 40A, thereby allowing communication view a data relay or mesh network. In such a situation, each personnel token 40 functions as a node to transmit data to another personnel token 40 until the data is able to be transferred to the server. The necessity of having PPE 54 increases the prevalence and redundancy of personnel tokens 40 that reduces the likelihood of the personnel tracking system 14 failing for one or more worker 52, while at the same time increasing the number of available personnel tokens 40 to transmit information within a mesh network when necessary.

The equipment tracking system 16 has a microcomputer 56 configured to receive diagnostic and operational information from a controller area network (CAN-bus) 58 that is on-board construction equipment 60, such as a dump truck, cement mixer, bulldozer, skid loader, and the like. In one embodiment, the microcomputer 56 is a ReliaGate 10-20. The microcomputer 56 has one or more wireless device 26 to transmit information to the server 28 and, in some embodiments, also has INS 42, GPS 44. Using INS 42, GPS 44, or the wireless device 26, the position, movement, and orientation of the construction equipment 60 is determined and transmitted to the server 28 upon reception from the microcomputer 56 or determined directly by the microcomputer 56 and transmitted to the server 28. The information received from the CAN-bus 58 is also transmitted to the server 28, which provides telemetry data on the current operation of the construction equipment, such as idle versus operating, speed, RPM, tire pressure, hours of operation, fuel level, error codes, maintenance requirements, current functionality being utilized, hydraulic positioning (e.g. lifting, dumping, churning, etc.). To collect additional information, the microcomputers 56 are also configured to communicate with LiDAR, linear actuators, and other construction equipment microcontrollers, ECUs, and subsystems.

The supervisory system 18 has a task management system 62 and an interactive display system 64. The task management system 62 is stored on the server 28 and accessed by a remote device 66, such as a desktop computer, laptop, tablet, phone, mixed reality smartglasses, or virtual reality headset. Each end user 68 has an authenticator 70, such as a login and password or biometric login, to access the task management system 62. Once accessed, the end user 68, such as a supervisor, general contractor, or subcontractor, can create one or more work profiles 72, one or more tasks 74, one or more zones 76, or communicate using a chat platform 78.

The work profile 72 allows the end user 68 to create an association between one or more worker 52 and a predefined cost 80 or a predefined hourly rate 82. For example, the work profile 72 for worker 52 Jim Foreman can be created and set an hourly rate 82 of $50.00 per hour.

To create the tasks 74, the end user 68 provides a description 84 of the task 74 along with a start date 86 and an end date 88. A predefined time 90 can also be associated with the task 74. One or more work profile 72 can then be assigned to the task 74.

The end user 68 can then view the 3D model 32 or the 2D model 34 of the work-site 22 from the site rendering system 12 to define one or more zone 76. Alternatively, the work-site 22 is presented from a third-party source, such as Google® Maps. To create the zones 76, the end user 68 uses the remote device 66 to define boundaries 92 of the zone 76 on the work-site 22. To define the boundaries 92, the end user can select one or more points on the work-site 22 or form a box using the remote device 66.

Once the zone 76 is defined, one or more task 74 is associated with the zone 76. In this way, the end user 68 can schedule various tasks 74 to be completed within the zone 76 by select workers 52. Using these defined parameters, the task management system 62 creates a schedule 94, which in some embodiments is a Gantt chart.

As work progresses at the work-site 22 and changes are made to the schedule 94, the chat platform 78 is used to communicate with other end users 68. This allows the end users 68 to adapt the schedule 94 as projects are completed early or delayed.

The work profiles 72, the tasks 74, and the zones 76, as well as any messages sent on the chat platform 78 are saved and associated with the end user 68 to be accessed any time.

The interactive display system 64 is also stored on the server 28 and accessed using the remote device 66. Alternatively, the interactive display system 64 is stored locally on the remote device 66 and receives updated information from the server 28.

On a display 96 of the remote device 66, a 3D environment 98 of the work-site 22 is displayed using information collected by the site rendering system 14 thereby allowing for zooming and rotation of the 3D model 32 or 2D model 34. A scaled icon, avatar, or rendering 100 of one or more workers 52, one or more construction equipment 60, and one or materials (e.g., parts, deliveries, materials, supplies, etc.) 102 is overlaid on the 3D environment 98 using information collected by the personnel tracking system 14 and the equipment tracking system 16.

The positions of the renderings 100 are continuously updated in real-time or near real-time (i.e. less than 1.5 second delay from information collection) from the continuously collected information of the personnel tracking system 14 and the equipment tracking system 16. Similarly, the work-site 22 is updated as the site rendering system 12 updates. This allows for the end user 68 to monitor the operation of the work-site 22 in real-time without being present but at the remote location 30. Similarly, the 3D environment 98 is continuously updating with the direction, speed, and position of workers 52 and equipment 60, the end user 68 can monitor the movement and orientation for each worker 52 and equipment 60.

One or more event identifiers 104 is also presented on the 3D environment 98 to draw attention to particular conditions. For example, one event identifier 104 signifies that maintenance is due on one or more construction equipment, such as a low fuel or underinflated tires—this is represented by a blue wrench in some embodiments. Another event identifier 104 signifies an injury or near accident 106, which can be represented by a yellow triangle, red exclamation point, or the like. The near accident 106 event occurs when one worker 52 gets within a predetermined proximity of a hazardous condition, another worker 52 or construction equipment 60. The near accident 106 can also occur with construction equipment 60 that is damaged or comes within a predetermined proximity of a hazardous condition or another construction equipment. The near accident 106 can also be determined based on dramatic changes in collected data from the equipment tracking system 16 related to speed, acceleration, rotation, orientation, or noise. If a worker 52 enters a zone 76 that the worker 52 is unqualified to be present in or the worker 52 is missing one or more piece of PPE 54, a near accident 106 can also be displayed.

The ability to highlight and track and record such events is useful for training, efficiency, and insurance purposes. The cameras 20 throughout the work-site 22 also record video, which can be displayed on the 3D environment 98 to present a live feed 108. Recorded video from the cameras 20 can be played back to evaluate, diagnose, address, and eliminate various event identifiers 104. The presence of multiple cameras 20 provides the ability to create a 360° view of an incident as well.

The server 28 stores recorded video from the cameras 20 and information collected from the personnel tracking system 14 and the equipment tracking system 16 on one or more storage devices 110. This allows the end user 68 to “playback” captured video and positions of workers 52 and equipment 60 to evaluate inefficacies and the like. Likewise, the ability to “playback” provides for the end user 68 to be absent from monitoring the interactive display system 64 because video and information can be played back that is missed.

To facilitate use of the interactive display system 64, the end user 68 uses the authenticator 70 to access the interactive display system 64, which in some embodiments is the same as the authenticator 70 used to access the task management system 62. Once the interactive display system 64 is accessed, the end user 68 is presented with the work-sites 22 associated with the end user 68.

The interactive display system 64 has one or more menus 112 presented in a dashboard 114 that assist in displaying and isolating select information from the site rendering system 12, the personnel tracking system 14, and the equipment tracking system 16 on the 3D environment 98. As shown in the illustrative embodiment of the Figures, the dashboard 114 has menus 112 for maps 116, filters 118, and analytics 120.

Within the maps 116 the end user 68 can select one or more zone 76 on a zone menu 118 previously defined in the task management system 62. By selecting one or more zone 76 from the zone menu 122, only those workers 52 and construction equipment 60 present in the selected zones are displayed. The selection of the zone 76 on the 3D environment 98 displays at least one live feed 108 from that zone 76. This allows the concurrent evaluation of zones 76 by the end user 68 even when the zones 76 are separated by a distance that is sufficient that concurrent on-site evaluation of the zones 76 would be physically impossible to perform.

Within the filters 118 the end user 68 can toggle one or more categories 120 on a category menu 124, such as personnel, equipment, and other. As shown in the illustrative embodiment, toggling the categories 120 for personnel, equipment, and other displays the renderings 100 for the workers 52, the construction equipment 60, and the materials 102 present at the work-site 22. By toggling off (e.g. unchecking) any of the categories 120 removes the related renderings 100 for that category 120. The ability to isolate different categories 120 allows the end user 68 to quickly focus in on a particular type of operation taking place at the work-site 22. For example, if only the construction equipment 60 is toggled to display, the end user 68 can identify construction equipment 60 that are idle and determine whether to transition that construction equipment 60 to a new task 74 or sublease the construction equipment 60 to another work-site 22. This in turn allows the end user 68 to use resources in a more efficient manner.

Within the analytics 120 the end user 68 can select an attribute 126 from an attribute menu 128. As seen in the illustrative embodiment, the attributes 126 include safety, security, attendance, and cost and field control. For example, if the safety attribute 126 is toggled on, only those workers 52 and construction equipment 60 that pose a safety risk are displayed which is further signified by the related event identifier 104.

When the security attribute 126 is toggled, missing construction equipment 60 or materials 102 are displayed, which may include a lightened rendering 100 if the construction equipment 60 or materials 102 is not present on the work-site 22 any longer.

The attendance attribute 126 displays the location of workers 52 and construction equipment 60 that are not present in the correct zone 76. Similarly, tardiness and absence can be tracked by the personnel tracking system 12 by noting the time the worker 52 arrives in the assigned zone 76 and when the worker 52 leaves the zone 76. Additionally, upon completion of the assigned task 74, the worker 52 or end-user 68 can indicate the task 74 is complete. The time of completion can be compared with the start date 86 and end date 88 entered in the task management system 62. This allows the schedule 94 to be updated in real-time (e.g. rolling Gantt chart), which allows for other tasks 74 to be adjusted accordingly.

By tracking worker 52 attendance and task 74 completion, a reliability rating 128 can be derived that reflects the ability of the worker 52 to accomplish work correctly and in a timely manner. The reliability rating 128 can later be taken into consideration when workers 52 and their crews are selected for involvement on particular tasks 74.

To obtain additional information, the rendering 100 is selected, which displays a details window 130 for that worker 52 or construction equipment 60. As shown in the Figures, the details window 18 displays such information as a name 130, a headshot 132, the current zone 76, the assigned zone 76, the reliability rating 128, and information on missing PPE 54. Similarly, selecting construction equipment 60 provides information collected from the CAN-bus 58 by the equipment tracking system 16.

The cost and field attribute 126 provides a cost heat map 134 of the costs being incurred within a particular zone 76 or entire work-site 22 in real-time or over an elapsed period of time. The cost heat map 134 utilizes the costs related to workers 52, construction equipment 60, and tasks 74, and zones 76 defined in the task management system 62 in conjunction with the position of workers 52, construction equipment 60, and materials 102 collected by the personnel tracking system 12 and equipment tracking system 14 to overlay varying degrees of cost by color code that intensifies as costs increase in an area. In this way, the heat map provides and immediate visual summary of costs.

The cost heat map 134, in one embodiment, is determined by cost based on individual wages as a function of tracked latitude and longitude. For instance:

$$C ( i , j ) = ( \frac{i}{m} X , \frac{h}{n} Y ) , ( \frac{i + 1}{m} X , \frac{j}{n} Y ) , ( \frac{i + 1}{m} X , \frac{j + 1}{n} Y ) , ( \frac{i}{m} X , \frac{j + 1}{n} Y ) ∀ 0 \leq i , j < m , n$$

C=is wage per second
X, Y=are dimensions of the defined area
m, n=grid points superimposed on the 3D environment 98 within the defined area
j=are counters to loop all grid points (i+1) (j+1);
T=personnel tokens/microcomputers
t=elapsed time
   Where i and j are initially set to zero such that C(i,j)=O∀i,j. Which allows determination of where T, and therefore the corresponding C(i,j) is positioned and T′s per second wage C. C(i,j) is updated by C(i,j)+C. Given the C(i,j)s the cost heat map 134 may be superimposed onto the work site 22.

In some embodiments the interactive display system 64 uses an augmented reality display or headset 96 that displays the 3D environmental 98 on a raised platform 136 (not shown) so that multiple end users 68 can cooperatively monitor one or more work-site 22 or zones 76. Alternatively, the augmented reality display 96 is displayed on a surface, such as a ceiling, wall, or floor 138 (not shown) such that the end-user 68 can comfortably monitor one or more work-site 22 or zones 76.

Although the present invention has been presented in the context of construction, other embodiments are contemplated. For example, the present invention can be used to track responding fire fighters and firetrucks, especially in large scale operations such as a forest fire that requires multiple zones. Another example is use in mining and in particular, when a mine collapses and the location of miners is not otherwise discernable.

Therefore, an operational monitoring system 10 has been provided that provides accurate, complete, and real-time information about a work-site, monitors and evaluates machinery, equipment, and personnel from a remote location, provides a three-dimensional interactive display of a work-site, provides monitoring, efficiency, and progress information from anywhere at any time, stores historic data, including video, for evaluation and review, increases efficiency, decreases costs, saves money, improves safety and security, and facilitates communication, provides real-time supervision of multiple work-sites that are remote from one another in a contextual environment, provides for fluid communication between numerous individuals, collects and provides on-demand, real-time strategic work-site information for off-site use, and improves upon the art.

From the above discussion and accompanying figures and claims it will be appreciated that the operational monitoring system 10 offers many advantages over the prior art. It will be appreciated further by those skilled in the art that other various modifications could be made to the device without parting from the spirit and scope of this invention. All such modifications and changes fall within the scope of the claims and are intended to be covered thereby. It should be understood that the examples and embodiments described herein are for illustrative purposes only and that various modifications or changes in the light thereof will be suggested to persons skilled in the art and are to be included in the spirit and purview of this application.

What is claimed is:

1. An operational monitoring system comprising:
a site rendering system having a plurality of cameras positioned around a work-site, wherein the plurality of cameras are configured to capture at least one image at a predetermined interval;
a personnel tracking system having at least one personnel token attached to a worker, wherein the personnel token is configured to track the position of the worker and is in communication with the server;
an equipment tracking system having at least one microcomputer in communication with a CAN-bus of a construction equipment, wherein the microcomputer is configured to track the position of the construction equipment;
a server in communication with the site rendering system, the personnel tracking system, and the equipment tracking system, wherein the server is configured to render a model of the work-site based on the at least one image captured by the plurality of cameras; and
a supervisory system in communication with the server and having an interactive display system configured to display a 3D environment based on the model rendered by the server, wherein the position the worker and the equipment is displayed in real-time.

2. The operational monitoring system of claim 1 wherein the personnel tracking system is configured to track the orientation and movement of the worker.

3. The operational monitoring system of claim 1 wherein the microcomputer tracks diagnostic information of the CAN-bus.

4. The operational monitoring system of claim 1 further comprising a task management system configured to create and maintain at least one work profile, at least one task, and at least one zone on the 3D environment.

5. The operational monitoring system of claim 1 wherein the supervisory system is configured to display a cost heat map in real-time.
